(19) United States
(12) Patent Application Publication
(10) Pub. No.: US 2026/0180936 A1
(43) Pub. Date: Jun. 25, 2026

(54) INFORMATION PROCESSING APPARATUS, INFORMATION PROCESSING METHOD, AND NON-TRANSITORY COMPUTER READABLE STORAGE MEDIUM

(71) Applicant: CANON KABUSHIKI KAISHA, Tokyo (JP)

(72) Inventor: HISASHI TERAE, Tokyo (JP)

(21) Appl. No.: 19/425,337

(22) Filed: Dec. 18, 2025

(30) Foreign Application Priority Data
Dec. 24, 2024 (JP) 2024-227340

(51) Int. Cl. H04L 51/04; G06F 21/62; H04L 51/18

(52) U.S. Cl. CPC H04L 51/04; G06F 21/6209; H04L 51/18; G06F 2221/2141

(57) ABSTRACT

An information processing apparatus providing a chat service extracts a message including a link to a file in the message that is input, determines whether the message mentions a chat member, determines whether the mentioned member has an access right to the linked file, and when the mentioned member does not have access rights to the linked file, grant, based on input from a user, access rights to the mentioned member.

### BACKGROUND

### Field of the Technology

The present disclosure relates to an information processing technology for providing a chat service.

### Description of the Related Art

Applications that enable users to arbitrarily create group chat rooms or teams and to post messages in threads of the chat rooms or the teams have proliferated among organizations and individuals. Such applications have a function of sharing files with other users, in addition to a function of posting text messages.

In order to share a file with other users, it is necessary that the file be uploaded to a server, a link to the file be sent to the other users, and access rights to the linked file be appropriately given. In Japanese Patent Laid-Open No. 2020-57143, a message including the link to a file is transmitted to a user group, and when a user who does not have the access right to the file is included in the user group, the user is added to an access right group that has the access right to the file.

In the technology described in Japanese Patent Laid-Open No. 2020-57143, since the access right is updated by adding the user to the existing access right group, an access right to files other than the file linked in the transmitted message may also be simultaneously provided to the user. Therefore, there is a possibility that access rights may not be appropriately controlled, such as granting access rights to files to which access rights are not intended to be granted.

### SUMMARY

Aspects of the present disclosure provide an information processing apparatus that provides a chat service, the information processing apparatus including at least one memory that stores a program and at least one processor that executes the program to perform extracting a message including a link to a file uploaded to the chat service from messages posted to the chat service, managing access rights to the file of users of the chat service, where in management of the access rights, when a user mentioned in the extracted message is not granted an access right to the file, the access right is granted to the mentioned user.

Features of the present disclosure will become apparent from the following description of embodiments with reference to the attached drawings. The following description of embodiments are described by way of example.

### BRIEF DESCRIPTION OF THE DRAWINGS

FIG. 1 is a system configuration diagram illustrating a system of the present embodiment.

FIG. 2 is a diagram illustrating an example of the hardware configuration of a PC terminal, a mobile terminal, and a chat tool server.

FIG. 3 is a diagram illustrating an example of the software configuration of the chat tool server.

FIG. 4 is a diagram illustrating an example of the software configuration of the PC terminal and the mobile terminal.

FIG. 5 is a diagram illustrating an example of a screen displayed when a chat application is executed on the PC terminal.

FIG. 6 is a diagram illustrating an example of a screen displayed when the chat application is executed on the mobile terminal.

FIG. 7 is a flowchart for describing a process executed when a message including a link to a file is posted from the PC terminal and the mobile terminal according to a first embodiment.

FIG. 8 is a diagram illustrating an example of a screen displayed when displaying that a mentioned user does not have an access right and granting the access right to the user in the first embodiment.

FIG. 9A and FIG. 9B are a flowchart illustrating a process executed when a message including a link to a file is posted from the PC terminal and the mobile terminal according to a second embodiment.

FIG. 10A and FIG. 10B are diagrams illustrating an example of a screen displayed when a specific portion of a file is shared with a user who does not have an access right in the second embodiment.

FIG. 11 is a diagram illustrating an example of a screen displayed when a specific portion of a file is shared by a plurality of users who do not have access rights by specifying the users with check boxes in the second embodiment.

FIG. 12 is a flowchart illustrating a process executed when a message including a link to a file is posted from the PC terminal and the mobile terminal according to a third embodiment.

FIG. 13 is a diagram illustrating an example of a screen displayed when changing the access right to a file in a posted message in the third embodiment.

FIG. 14 is a flowchart for updating a specific portion of a file in a posted message in a fourth embodiment.

FIG. 15 is a diagram illustrating an example of a screen of a PC terminal 110 for updating the specific portion of the file in the posted message in the fourth embodiment.

### DESCRIPTION OF THE EMBODIMENTS

Hereinafter, embodiments for implementing the present disclosure will be described with reference to the drawings.

### First Embodiment

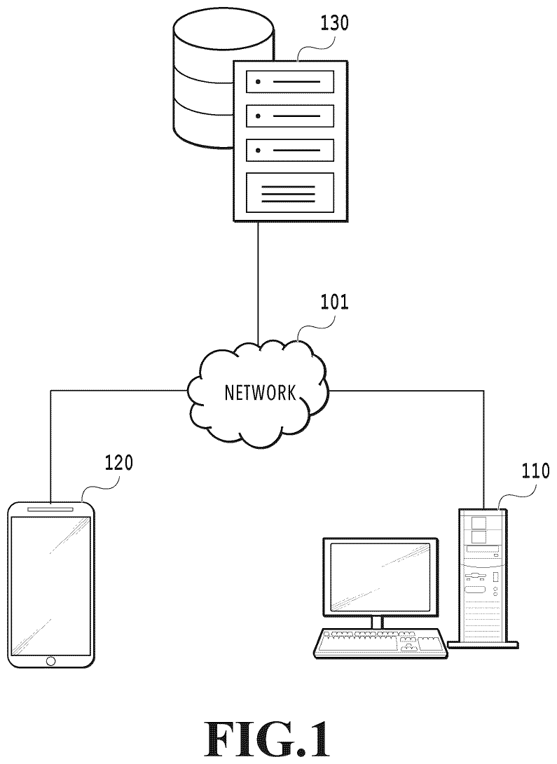

FIG. 1 is a system configuration diagram illustrating a system according to a first embodiment. A PC terminal 110, a mobile terminal 120, and a chat tool server 130 are connected to each other via a network 101. The PC terminal 110 is an information processing terminal such as a PC, and the mobile terminal 120 is an information processing terminal such as a smartphone or a tablet.

The PC terminal 110 and the mobile terminal 120 can always communicate with the chat tool server 130 via the network 101. The PC terminal 110 and the mobile terminal 120 can access files that are stored by the chat tool server 130 by specifying a Uniform Resource Locator (URL). The PC terminal 110 and the mobile terminal 120 can share files with other terminals by writing the URL to the chat tool server 130.

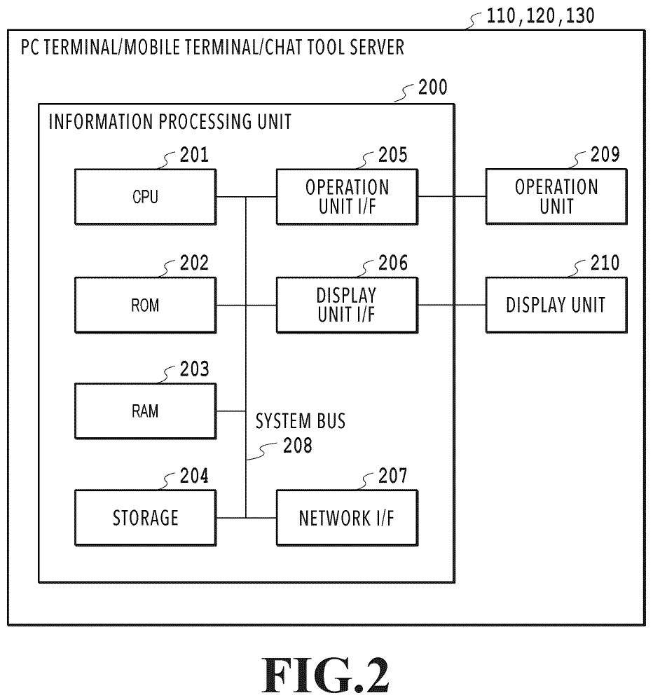

FIG. 2 illustrates an example of the hardware configuration of an information processing apparatus that can be used as the PC terminal 110, the mobile terminal 120, and the chat tool server 130 according to the present embodiment. Since there are no major differences in the main configurations of the PC terminal 110, the mobile terminal 120, and the chat tool server 130, these will be collectively described. The hardware of the PC terminal 110, the mobile terminal 120, and the chat tool server 130 includes an information processing unit 200, an operation unit 209, and a display unit 210. The information processing unit 200 includes a CPU 201. The CPU 201 starts an Operating System (OS) via a boot program stored in a ROM 202.

The CPU 201 loads an application program stored in a storage 204 into a RAM 203 and executes the application program on the OS to execute various processes. The RAM 203 is used as a working area for the CPU 201, and the storage 204 stores data such as the application program.

An operation unit I/F 205, a display unit I/F 206, and a network I/F 207, the CPU 201, the ROM 202, and the RAM 203 are all connected via a system bus 208. The operation unit I/F 205 is an interface with the operation unit 209 that includes a touch panel, a keyboard, a mouse, and the like, and outputs a user input received by the operation unit 209 to the CPU 201. The display unit I/F 206 outputs, to the display unit 210, image data to be displayed on the a display of the display unit 210. The chat tool server 130 does not necessarily need the operation unit 209 and the display unit 210. The network I/F 207 is connected to the network 101, and transmits and receives information to and from apparatuses on the network 101.

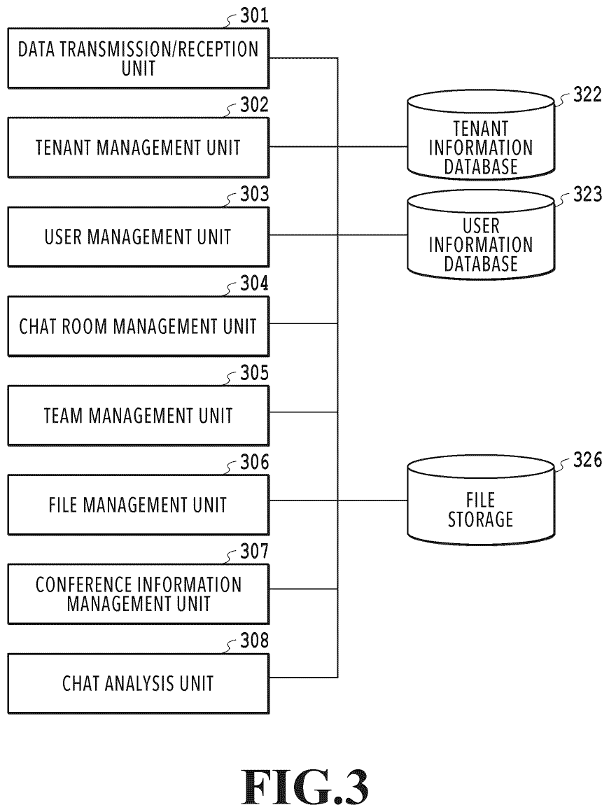

FIG. 3 illustrates an example of the software configuration of the chat tool server 130 that provides a chat service according to the present embodiment. The software configuration illustrated in FIG. 3 is realized by the CPU 201 executing a program stored in any of the above-described storage units, i.e., the ROM 202, the RAM 203, or the storage 204.

A data transmission/reception unit 301 transmits and receives message requests from the PC terminal 110 and the mobile terminal 120 that access a chat via the network 101, as well as data and files via the chat.

A tenant management unit 302 manages, in a tenant information database 322, information on tenants that defines the scope of use for each contracted user, such as a corporation and an individual, who uses the chat tool server 130. The data stored in the tenant information database 322 is saved in the storage 204.

A user management unit 303 manages, in a user information database 323, information such as the ID, authority, and affiliation of users who use the chat tool server 130. The data stored in the user information database 323 is saved in the storage 204.

A chat room management unit 304 manages users who participate in chat room arbitrarily created by users and the chat history.

A team management unit 305 performs management of users who participate in teams created by users, and threads and rights for each team.

A file management unit 306 manages the storage destinations, access rights, file update history, and the like of files uploaded by users, and transmits files in response to requests from users. The file management unit 306 manages, in a file storage 326, files and information such as access rights and history associated with the files. The data stored in the file storage 326 is saved in the storage 204.

A conference information management unit 307 manages chat rooms or meeting rooms for online meetings created in a team, and manages the schedules for meetings.

A chat analysis unit 308 analyzes the content of a chat that a user is about to post in a chat room or a thread in a team, and analyzes the history of past chats.

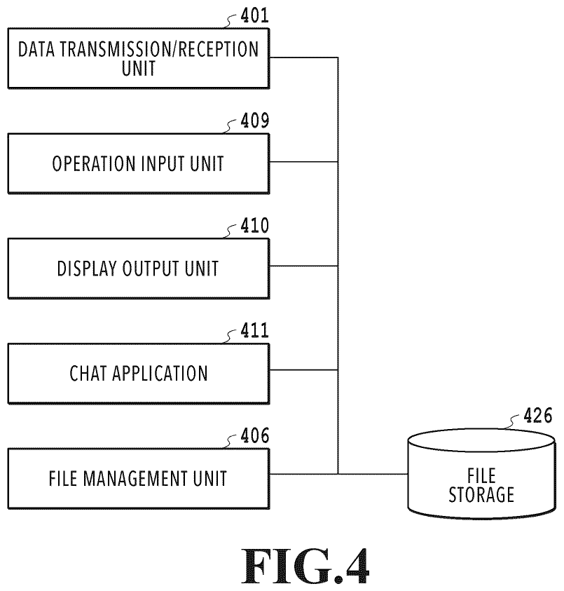

FIG. 4 illustrates an example of the software configuration of the PC terminal 110 and the mobile terminal 120 according to the present embodiment. In the present disclosure, the software configuration illustrated in FIG. 4 is realized by the CPU 201 executing a program stored in any of the storage units, i.e., the ROM 202, the RAM 203, or the storage 204.

A data transmission/reception unit 401 has a function of communicating with the chat tool server 130 via the network 101, and performing transmission of message requests as well as uploading and downloading of files. An operation input unit 409 receives user inputs related to messages and instructions accepted by the operation unit 209. A display output unit 410 displays various kinds of information on the display unit 210. A chat application 411 connects to the chat tool server 130, inputs messages and uploads files to the chat tool server 130, and obtains messages and files stored by the chat tool server 130. A file management unit 406 manages the uploaded files in a file storage 426. The files stored in the file storage 426 is saved in the storage 204.

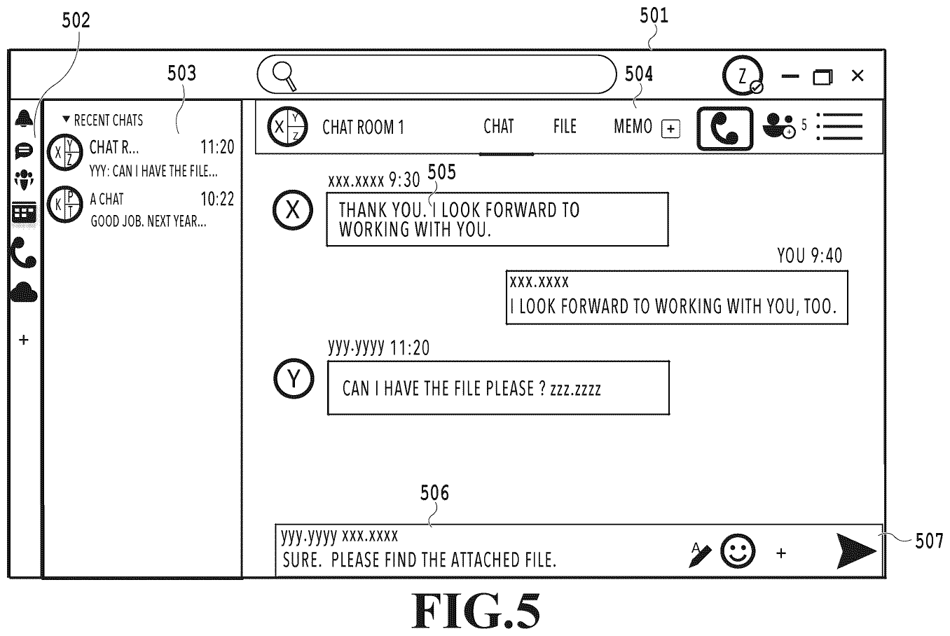

FIG. 5 illustrates an example of a chat room screen displayed by a chat application running on the PC terminal 110 according to the present embodiment. A chat room screen 501 is displayed on the display unit 210 by the chat application 411 of the PC terminal 110 by obtaining data from the chat tool server 130.

When a chat icon is selected from a menu bar 502 on the left-side of the chat room screen 501, a chat list 503 is displayed. Selecting one chat room from the displayed chat list 503 results in a chat room screen 504 being displayed. A chat 505 of “chat room 1” is displayed on the chat room screen 504. When a text, a file link URL, or the like is entered in a chat input bar 506 and a post button 507 is pressed, information entered in the chat input bar 506 is transmitted to the chat tool server 130. The transmitted information is posted to the chat in “chat room 1” and displayed on the chat room screen 504. Members participating in “chat room 1” are notified when there is a new post to “chat room 1,” and the content of the post is shared among the members.

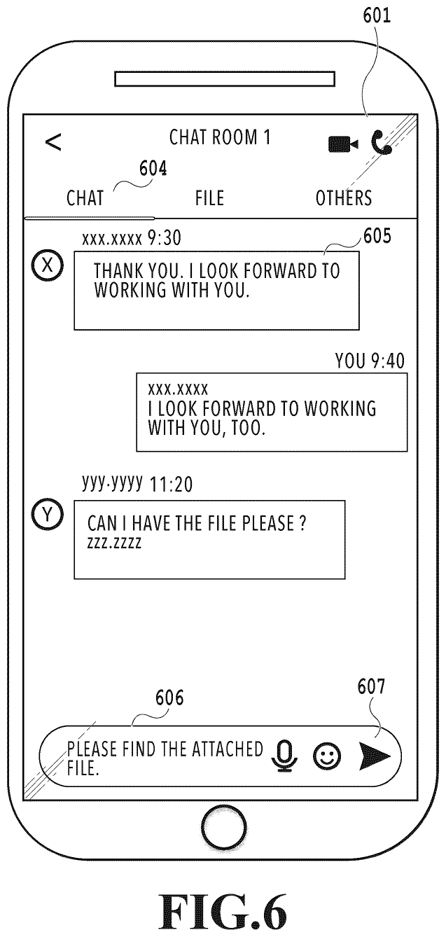

FIG. 6 illustrates an example of a chat room screen displayed by a chat application running on the mobile terminal 120 according to the present embodiment. A chat room screen 601 is displayed on the display unit 210 by the chat application 411 of the mobile terminal 120 by obtaining data from the chat tool server 130.

A chat room screen 604 is displayed on the chat room screen 601, and a chat 605 in “chat room 1” is displayed. When a text, a file link URL, or the like is entered in a chat input bar 606 and a post button 607 is pressed, information entered in the chat input bar 606 is transmitted to the chat tool server 130. The transmitted information is posted to the chat in “chat room 1” and displayed on the chat room screen 604. Members participating in “chat room 1” are notified when there is a new post to “chat room 1,” and the content of the post is shared among the members.

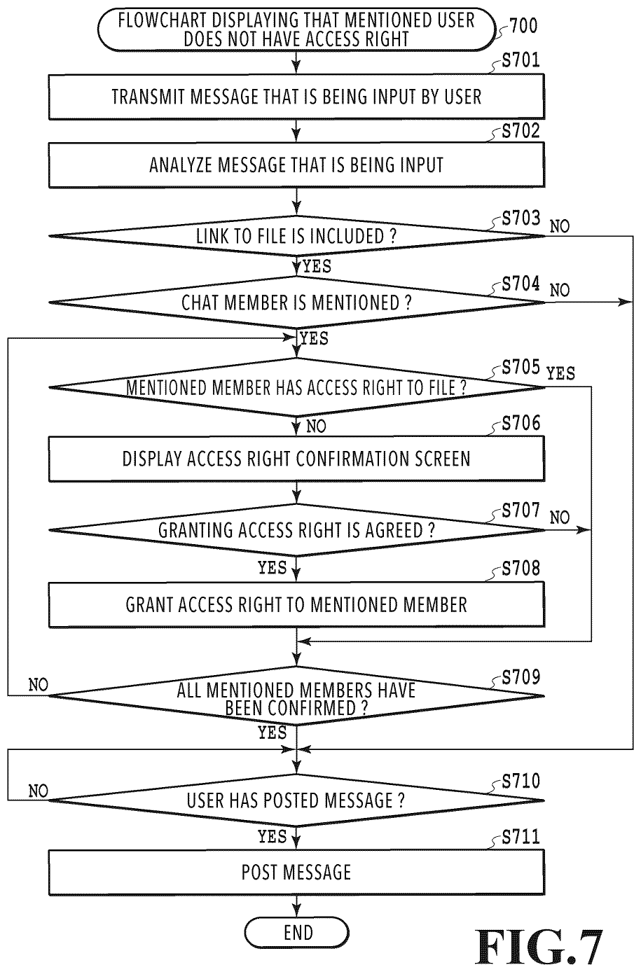

FIG. 7 illustrates a flowchart 700 for a process executed when a message including a link to a file is posted from the PC terminal 110 or the mobile terminal 120 according to the present embodiment. In the present embodiment, the process illustrated in FIG. 7 is realized by the CPU 201 executing a program stored in any of the storage devices, i.e., the ROM 202, the RAM 203, or the storage 204. Hereinafter, while a description will be provided of the process of the PC terminal 110, the description applies to the mobile terminal 120.

In S701, the chat application 411 accepts an input of a message from a user in the chat input bar 506, and transmits the message that is input by the user to the chat analysis unit 308 of the chat tool server 130.

In S702, the chat analysis unit 308 analyzes the message that is input and is transmitted from the chat application 411.

In S703, based on the analyzing result of the message, the chat analysis unit 308 extracts a message that is input and including the link to a file. When the link to the file is included in the message that is input, the process proceeds to S704. When the link to the file is not included in the message that is input, the process proceeds to S710.

In S704, the chat analysis unit 308 determines whether the message mentions a chat member. Mentioning refers to a function for specifying, in a message, a member participating in a chat and notifying, by the chat application 411, the specified member that the member has been mentioned. In S704, when at least one or more members are mentioned, the process proceeds to S705. When no chat member is mentioned, the process proceeds to S710.

In S705, the chat analysis unit 308 analyzes the link to the file included in the message to obtain information of the linked file from the file management unit 306 and information of one of the mentioned members from the user management unit 303. The chat analysis unit 308 determines, based on the obtained file information and member information, whether the mentioned member has an access right to the linked file. When the member does not have an access right to the file, the process proceeds to S706. When the member already has the access right, the process proceeds to S709.

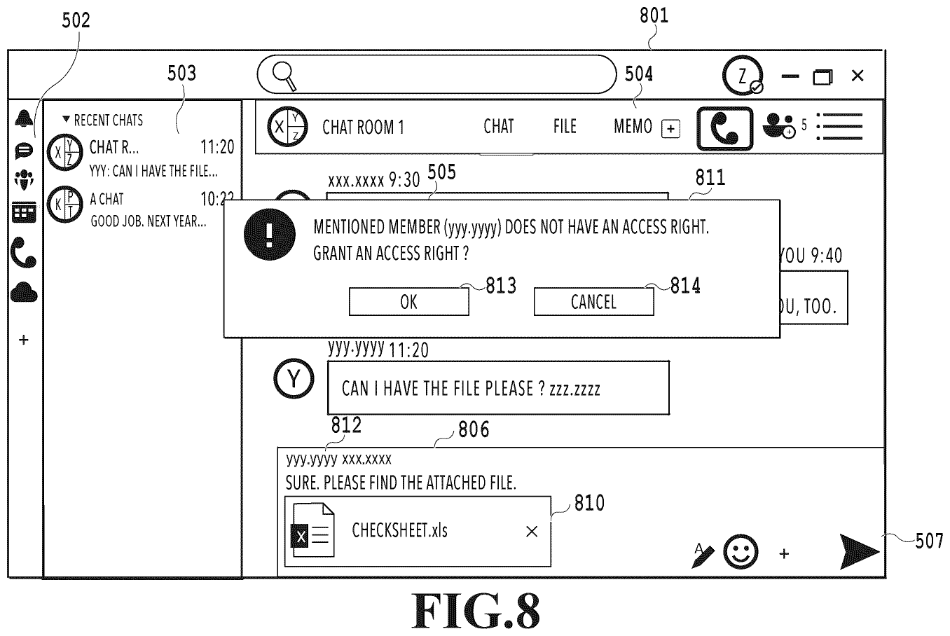

In S706, the chat analysis unit 308 transmits, to the chat application 411, a message asking whether to grant the mentioned member an access right to the linked file, and displays the message on the chat room screen 501. FIG. 8 illustrates an example of a screen displayed when a message indicating that the mentioned user does not have an access right is displayed and the access right is granted according to the present embodiment.

In a chat room screen 801 illustrated in FIG. 8, mentions 812 to chat members and a file link 810 are displayed in a chat input bar 806. When the members specified in the mentions 812 do not have an access right to the file of this file link 810, the chat application 411 displays the message received from the chat analysis unit 308 as a dialog 811. The message displayed in the dialog 811 asks the user whether to grant an access right. In the example illustrated in FIG. 8, while the message for yyy.yyyy is displayed in the dialog 811, when xxx.xxxx does not have an access right to the linked file, a similar message is also displayed for xxx.xxxx.

In S707, the file management unit 306 obtains, from the chat application 411, information indicating that an OK button 813 or a cancel button 814 of the dialog 811 has been pressed. When the user agrees to grant the access right and presses the OK button 813, the process proceeds to S708. When the user does not agree to grant the access right and presses the cancel button 814, the process proceeds to S709.

In S708, when the file management unit 306 receives information that indicates that the OK button 813 has been pressed and that is transmitted from the chat application 411, the file management unit 306 grants the mentioned member an access right to the linked file.

In S709, the chat analysis unit 308 determines whether checking of the access right has been performed on all the members specified by the mentions 812. When the checking has been performed, the process proceeds to S710. When there is a member for which the checking has not been performed, the process returns to S705.

In S710, the chat application 411 waits for the user to post the message that is input.

In S711, when the user presses the post button 507, the chat application 411 transmits the message entered in the chat input bar 506 to the chat room management unit 304 of the chat tool server 130. The chat room management unit 304 updates the chat room information based on the received message, and the chat application 411 obtains the updated chat room information to reflect the updated chat room information to the chat room screen 504.

As described above, in the present embodiment, when a member in a chat room does not have an access right to a file linked in a posted message, an access right to the file can be granted to the member mentioned in the message.

### Second Embodiment

In the first embodiment, when a member in a chat room does not have an access right to a file linked to a message, a dialog for granting an access right to the entire file is displayed. There is a case where it is not desired to grant rights to refer to and edit an entire file. For example, in the case of a file with a plurality of pages or sheets, it is sufficient to allow reference to only a part of the pages or sheets in many cases. Therefore, in a second embodiment, reference to only a part of a file linked to a message is allowed.

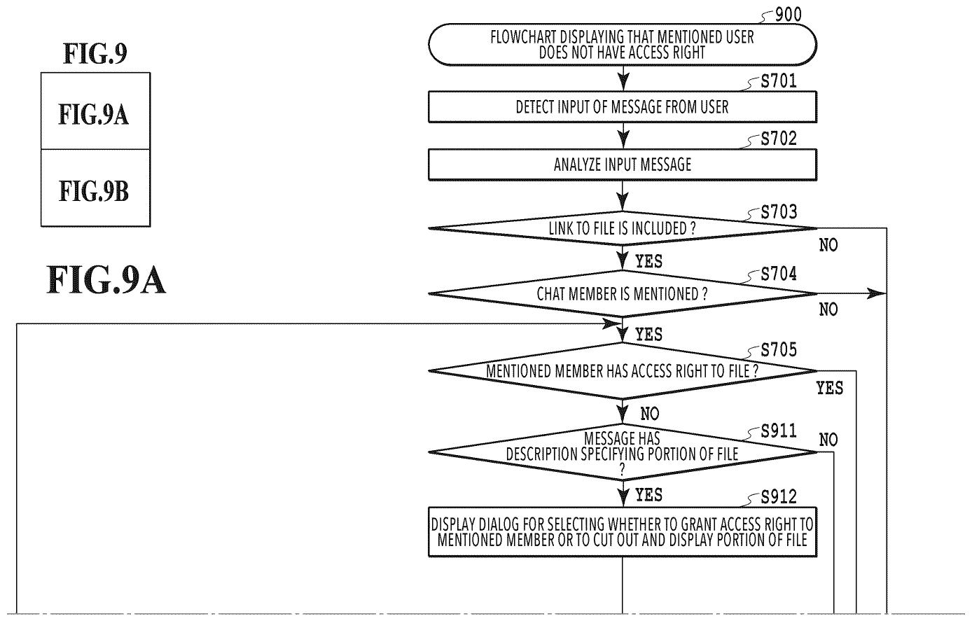

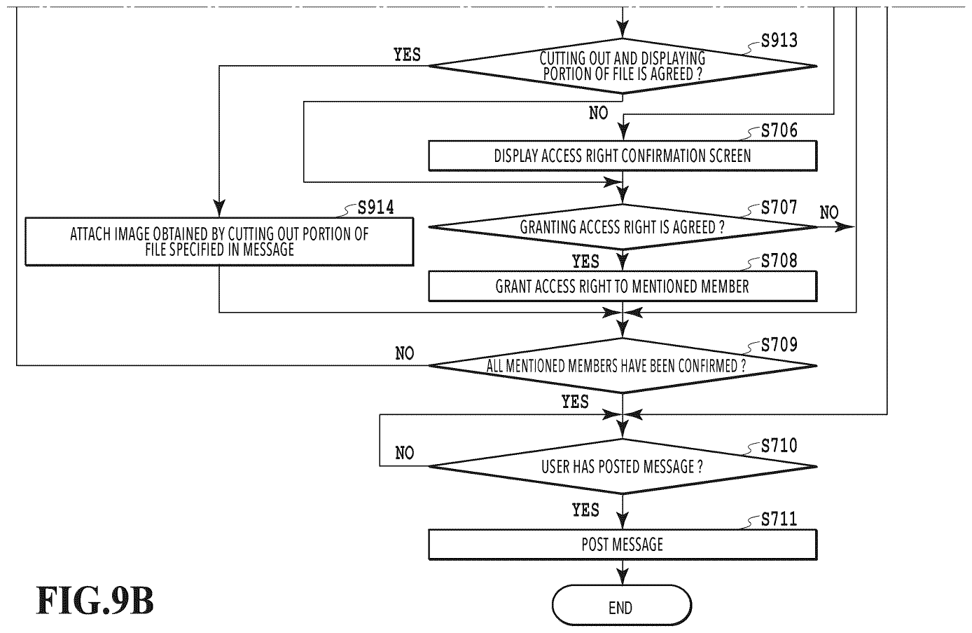

FIGS. 9A and 9B illustrate a flowchart 900 for describing a process executed when a message including a link to a file is posted from the PC terminal 110 or the mobile terminal 120 according to the present embodiment. In the present disclosure, the process illustrated in FIGS. 9A and 9B is realized by the CPU 201 executing a program stored in any of the storage units, i.e., the ROM 202, the RAM 203, or the storage 204. Hereinafter, a description will be provided of a part different from the process illustrated in FIG. 7.

In S911, when it is determined in S705 that the member does not have an access right to the file, the chat analysis unit 308 detects a description in the message that specifies a specific portion of the file. In S911, when there is no description that specifies a specific portion of the file in the message, the process proceeds to S706. When there is description that specifies a specific portion, the process proceeds to S912. The specific portion of the file is, for example, a paragraph number in a document in the case of a document file, a page number in the case of a presentation material file, a sheet name in the case of a worksheet, and the like. The description specifying a specific portion of a file is specifically a keyword that indicates a portion of a file that is predetermined for each file extension. The chat analysis unit 308 stores a table that associates file extensions with keywords that indicate portions of files, and determines whether a keyword corresponding to a file extension is included in a message. Table 1 illustrates an example of a table that associates file extensions with keywords that indicate portion. For example, when the file extension is “.xls” and there is a sheet [number] in a message, it is considered that a portion is specified.

### (Correspondence Table Between File Extensions and Keywords Specifying Portions)

TABLE 1

| File extension | Keyword |
|---|---|
| .xls | sheet [number] |
| .ppt | page [number] |
| .doc | [number] section, [number] chapter, [number] verse |

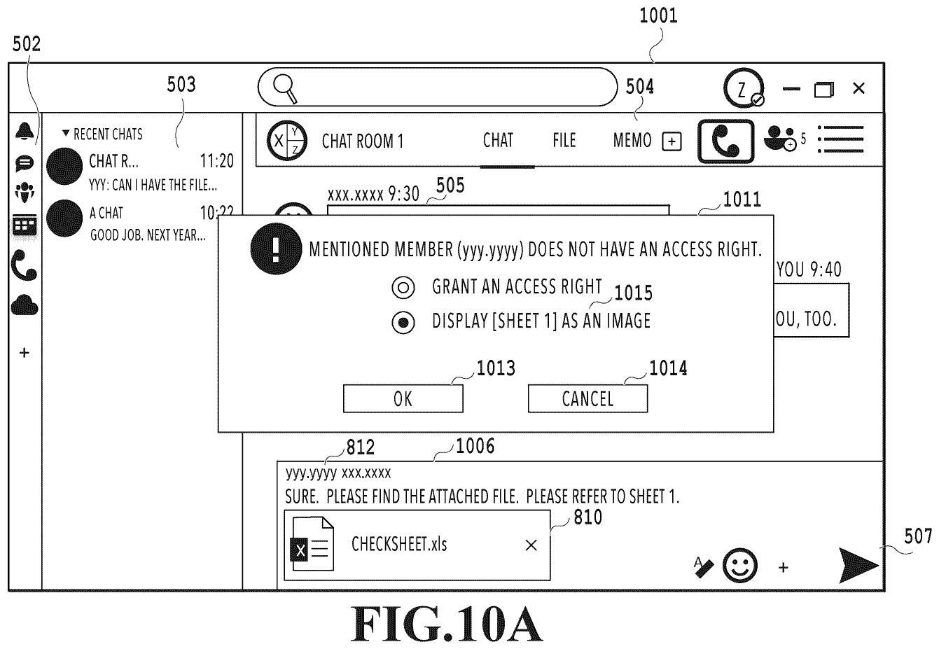

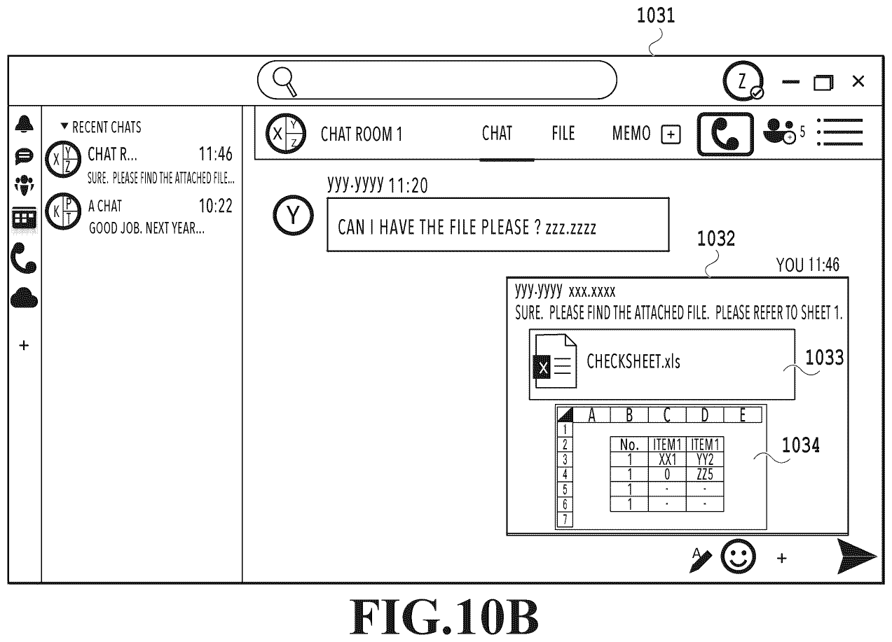

In S912, based on an instruction from the chat analysis unit 308, the chat application 411 displays a dialog for the mentioned member to select whether to grant an access right to the entire file or to display only specific portion of the file. FIG. 10A illustrates a chat room screen 1001 as a display example of a screen at this time. When a link to a file is written in a chat input bar 1006 on the chat room screen 1001 and a specific portion of the file, such as “sheet 1,” is written in the message that is entered, a dialog 1011 is displayed. The user can, by operating a radio button 1015 in the displayed dialog 1011, select whether to grant an access right to the file or to display an image of sheet 1 of the file linked to the message.

In S913, when “grant an access right” is selected using the radio button 1015 and an OK button 1013 is pressed, the chat application 411 transmits the result to the chat analysis unit 308, and the process proceeds to S708 via S707. When “display [sheet 1] as an image” is selected using the radio button 1015 and the OK button 1013 is pressed, the result is transmitted to the chat analysis unit 308, and the process proceeds to S914.

In S914, based on the selection result received from the chat application 411, the chat analysis unit 308 performs a process to cut out and display a specific portion of the file specified by the user. Specifically, the chat analysis unit 308 instructs the file management unit 306 to obtain the corresponding file from the file storage 326, obtains an image representing the portion of the file specified in the message, attaches the obtained image to the message, and the message is posted in S711. FIG. 10B illustrates an example of a chat room screen when the image is attached to the message in S914. On a chat room screen 1031, a file link 1033 and an image 1034 of the specific portion of the file are attached to a message 1032 posted by a user in the chat.

In S914, while an image is used to cut out a portion of a file, it is not limited to an image, and only a specific portion of the same file type may be cut out to generate another file, and an access right to the file may be granted. The file type of the file generated by cutting out only the specific portion may be changed, e.g., “.xls” may be converted to PDF (Portable Document Format) or PostScript.

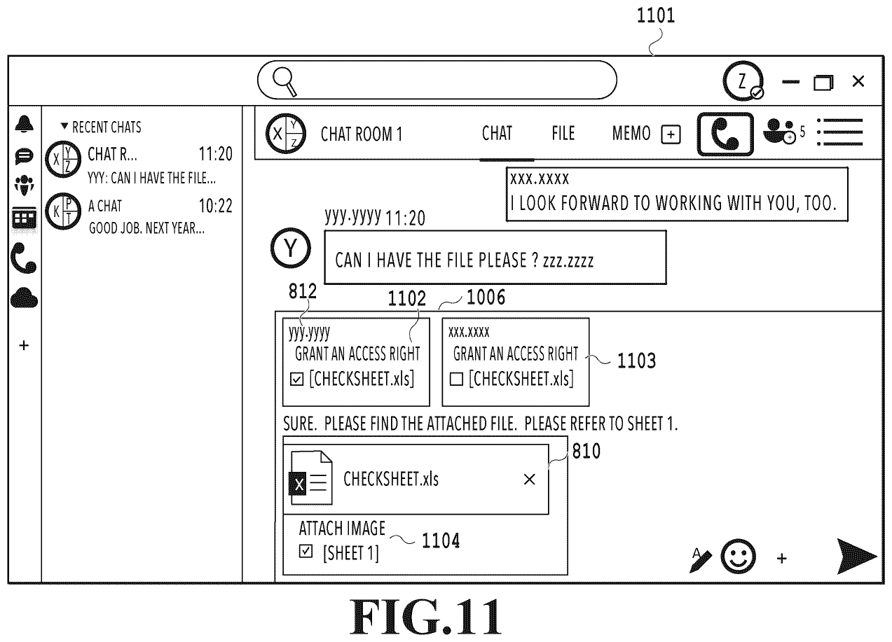

When granting access rights to a plurality of members or selecting attachment of an image obtained by cutting out a specific portion, the dialog 1011 does not necessarily need to be displayed. As illustrated in a chat room screen 1101 in FIG. 11, check box may be displayed in the chat input bar 1006 for specifying whether to grant an access right to each mentioned member and whether to attach an image. In FIG. 11, it is set in a check box 1102 to grant an access right to the attached file to yyy.yyyy, and similarly, it is set in a check box 1103 to not grant the access right to xxx.xxxx. It is set in a check box 1104 to attach an image representing a specific portion of the file.

As described above, in the present embodiment, it is possible to allow reference to only a specific portion of a file that corresponds to a message content without granting an access right to the entire file.

### Third Embodiment

In the first embodiment, when a chat member in a chat room does not have an access right to a file, a dialog for granting the access right to the file is displayed. In many common chat services, after a message is posted to a chat room, editing and correction of the posted message are allowed. A posted message to which a link to a file is attached can also be edited, but there are cases where it is desired to change the access right that has been erroneously set. In a third embodiment, when editing a posted message, the access right of a member can be changed, and the access right can be newly granted or revoked.

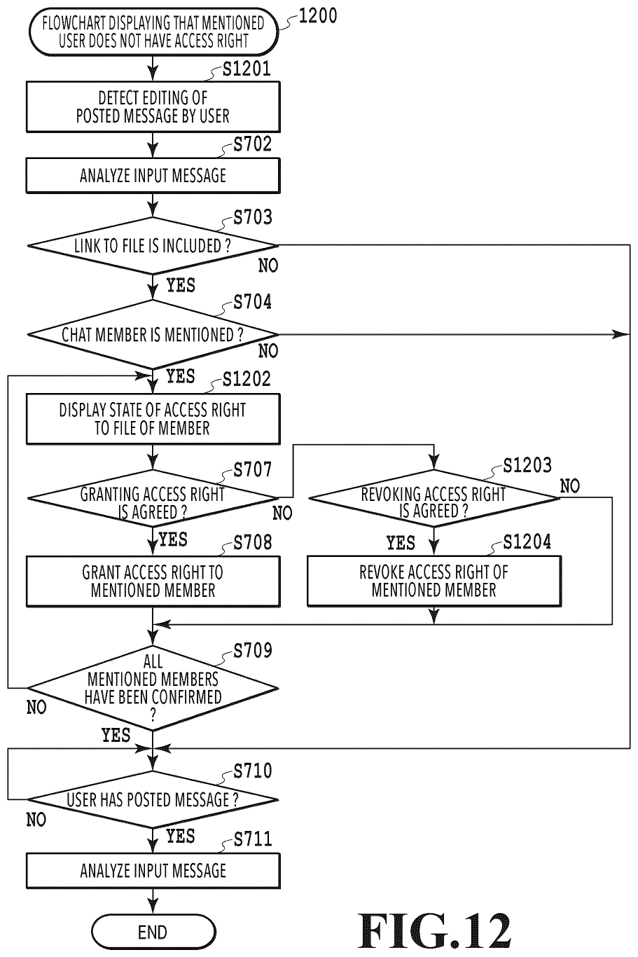

FIG. 12 illustrates a flowchart 1200 for describing a process executed when a message including a link to a file is posted from the PC terminal 110 or the mobile terminal 120 according to the present embodiment. In the present embodiment, the process illustrated in FIG. 12 is realized by the CPU 201 executing a program stored in any of the storage devices, i.e., the ROM 202, the RAM 203, or the storage 204. A description will be provided below of a portion different from the flowchart 700.

In S1201, when the chat application 411 detects that the user is performing an input to edit a posted message, the chat application 411 transmits the message that is input to the chat tool server 130.

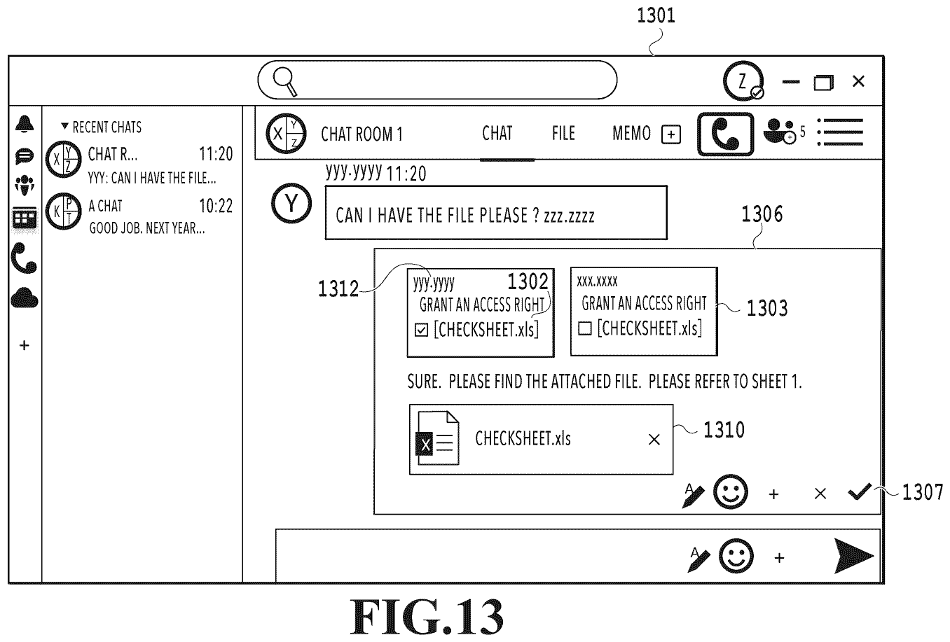

In S1202, the chat application 411 displays information obtained from the file management unit 306 and the user management unit 303 regarding the access right to the file attached to the posted message that has been changed by the user. FIG. 13 illustrates an example of a chat room screen 1301 displayed at this time. The message edit bar 1306 includes mentions 1312 to members and a file link 1310. The states of the access rights to the file link of the mentioned members are illustrated in check boxes 1302 and 1303. A check box with a check mark indicates that the access right is granted, while a check box without a check mark indicates that the access right is not granted.

In S707, the chat application 411 changes the state of the check mark in the check box displayed in S1202. When a check mark is placed in the check box, the chat application 411 considers that it is agreed to newly grant an access right, and the process proceeds to S708. When the check mark is removed/from the check box, the process proceeds to S1203.

In S1203, the chat application 411 asks the user whether the user agrees to revoke the access right. The chat application 411 displays, as a dialog, for example, a message asking whether to agree to revoke the access right, and confirms whether it is agreed to revoke the access right by whether the OK button or the cancel button is pressed. When the user agrees to revoke the access right, the process proceeds to S1204. When the user does not agree to revoke the access right, the process proceeds to S709.

In S1204, the chat application 411 transmits, to the file management unit 306, the file for which the access right is to be revoked. The file management unit 306 obtains information from the user management unit 303 regarding a member who has been granted an access right to the file for which the access right is to be revoked, and changes the access right of the obtained member. When the setting is changed as illustrated in FIG. 13 and the user presses a post button 1307, yyy.yyyy can access the attached checksheet.xls, but the access right of xxx.xxxx is revoked and xxx.xxxx can no longer access checksheet.xls.

As described above, in the present embodiment, a posted message with a link to a file can be edited to change the access right to the file, and the access right to the file can be newly granted or revoked.

### Fourth Embodiment

In the second embodiment, while the method is presented in which a chat member in a chat room is allowed to refer to only a portion of a file, there are cases where a file is edited later, or a posted message to which a link to a file is attached is edited. In a fourth embodiment, a method of updating an image obtained by cutting out a portion of an attached file will be described.

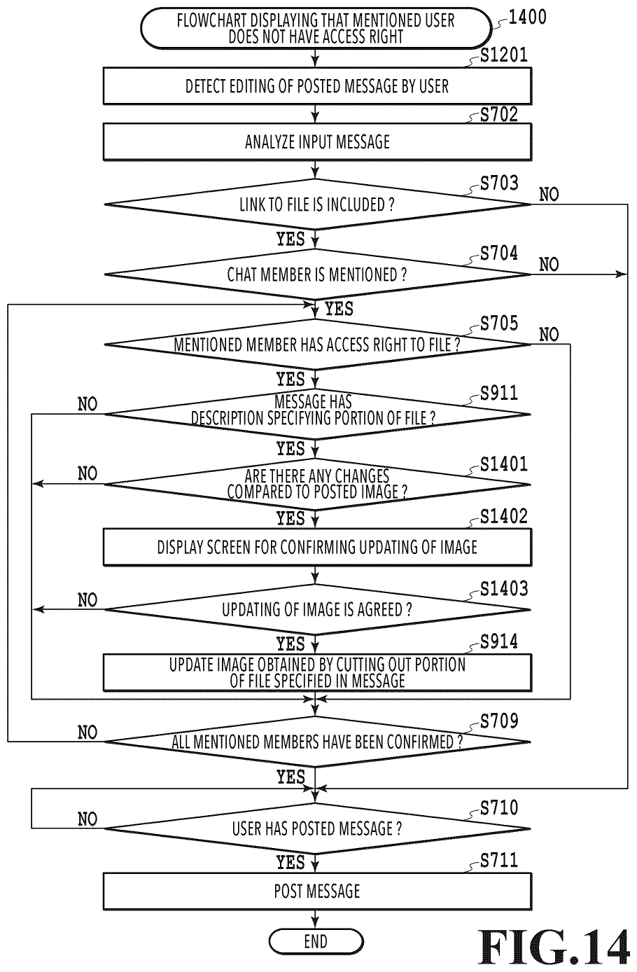

FIG. 14 illustrates a flowchart for describing a process executed when a message including a link to a file is posted from the PC terminal 110 or the mobile terminal 120 according to the present embodiment. In the present embodiment, the process illustrated in FIG. 14 is realized by the CPU 201 executing a program stored in any of the storage devices, i.e., the ROM 202, the RAM 203, or the storage 204. A description will be provided below of a portion different from the flowcharts 700, 900, and 1200. Since S1201, S702 to S705, and S911 are the same as those in the first to third embodiments, a description will be omitted herein.

In S1401, the chat analysis unit 308 obtains, from the chat room management unit 304, image information obtained by cutting out the specific portion of the file attached to the chat room. The description specifying the portion of the file in the message and the file information obtained from the file management unit 306 are obtained, and it is determined whether there is a difference between them. When there is no difference, the process proceeds to S709. When there is a difference, the process proceeds to S1402.

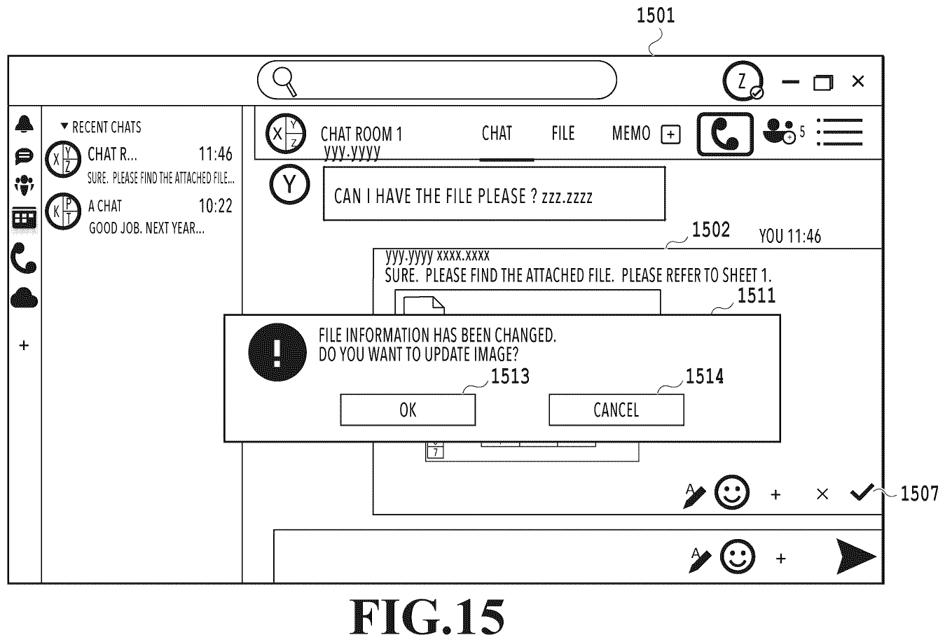

In S1402, the chat application 411 displays a chat room screen 1501 as illustrated in FIG. 15. When there is a difference between the image obtained by cutting out the specific portion of the file attached to a chat editing bar 1502, the message being edited, and the content of the link destination of the file, a dialog 1511 is displayed.

In S1403, when the user presses an OK button 1513 in the dialog 1511 to agree to update the image, the chat application 411 proceeds to S914. When the user presses a cancel button 1514, the chat application 411 proceeds to S709.

Since S911, S914, S710, and S711 are the same as those in the first and second embodiments, a description will be omitted herein.

As described above, in the present embodiment, when a message content is updated, it is also possible to update an image that is obtained by cutting out a portion of a file and that is attached to allow reference to only a specific portion of the file corresponding to the message content.

The present disclosure makes it easier to share a file with a specific user when sharing the file in a chat application.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-227340, filed Dec. 24, 2024, which is hereby incorporated by reference herein in its entirety.

What is claimed is:

1. An information processing apparatus that provides a chat service, the information processing apparatus comprising:
at least one memory that stores a program; and
at least one processor that executes the program to perform:
extracting a message including a link to a file uploaded to the chat service from messages posted to the chat service; and
managing access rights to the file of users of the chat service,
wherein in management of the access rights, when a user mentioned in the extracted message is not granted an access right to the file, the access right is granted to the mentioned user.

2. The information processing apparatus according to claim 1,
wherein in management of the access rights, when a user who posted the message agrees to grant the access right, the access right is granted to the mentioned user.

3. The information processing apparatus according to claim 1,
wherein in management of the access rights, when a user who posted the message does not agree to grant the access right, the access right is not granted to the mentioned user.

4. The information processing apparatus according to claim 1,
wherein in management of the access rights, when the mentioned user is granted an access right to the file, the access right is revoked from the mentioned user based on input from a user who posted the message.

5. The information processing apparatus according to claim 1,
wherein in extraction of the message, a message including a link to a file is extracted from an updated message that is input by a user to edit a message that has been posted to the chat service, and
in management of the access rights, when an instruction to change the access rights is included in the updated extracted message from the user who the message, the access right of the mentioned user is changed.

6. The information processing apparatus according to claim 1,
wherein in extraction of the message, a message including the link is extracted from a message that is input by a user to be posted to the chat service.

7. A method for providing a chat service, the information processing method comprising:
extracting a message including a link to a file uploaded to the chat service from messages posted to the chat service; and
managing access rights to the file of users of the chat service,
wherein in management of the access rights, when a user mentioned in the extracted message is not granted an access right to the file, the access right is granted to the mentioned user.

8. A non-transitory computer readable storage medium storing a computer program for executing a method of an information processing apparatus that provides a chat service, the method comprising:
extracting a message including a link to a file uploaded to the chat service from messages posted to the chat service; and
managing access rights to the file of users of the chat service,
wherein in management of the access rights, when a user mentioned in the extracted message is not granted an access right to the file, the access right is granted to the mentioned user.
